(19) United States
(12) Patent Application Publication
(10) Pub. No.: US 2009/0011394 A1
(43) Pub. Date: Jan. 8, 2009

(54) LIMB HEMORRHAGE TRAUMA SIMULATOR

(75) Inventors: Dwight MEGLAN, Westwood, MA (US); Robert Waddington, Silver Spring, MD (US); Marjorie Moreau, Arlington, VA (US); Paul Sherman, Seattle, WA (US); Howard Champion, Annapolis, MD (US)

Correspondence Address: PILLSBURY WINTHROP SHAW PITTMAN, LLP, P.O. BOX 10500, MCLEAN, VA, 22102, US

(73) Assignee: SimQuest LLC, Silver Spring, MD (US)

(21) Appl. No.: 11/695,444

(22) Filed: Apr. 2, 2007

Related U.S. Application Data
(60) Provisional application No. 60/791,893, filed on Apr. 14, 2006.

(51) Int. Cl. G09B 23/30

(52) U.S. Cl. 434/268

(57) ABSTRACT

A limb hemorrhage trauma simulator provides didactic and hands-on training for the prehospital treatment of a limb trauma victim. The simulator realistically simulates a wounded limb, providing simulated pulse and hemorrhage blood flow. The simulator provides a simulated scenario in which the wound occurred. The student then responds to the scenario by treating the limb via direct pressure, tourniquet, and/or wound analysis. The simulator modifies hemorrhage blood flow and pulse in response to direct or tourniquet pressure applied to the limb. The simulator records the student's actions to provide feedback and grade the student's response.

### CROSS-REFERENCE TO RELATED APPLICATIONS

This application claims the benefit of priority of U.S. provisional application Ser. No. 60/791,893, filed Apr. 14, 2006, the entire contents of which are incorporated by reference herein.

The U.S. Government has a paid-up license in this invention and the right in limited circumstances to require the patent owner to license others on reasonable terms as provided for by the terms of SBIR Grant No. DAMD17-03-C-0037 (“Medical Modeling and Simulation—Exsanguinating Hemorrhage From Limbs”) awarded by the Department of Defense.

### BACKGROUND OF THE INVENTION

1. Field of the Invention

The present invention relates to devices and methods for training individuals to treat an individual with a hemorrhaging limb injury.

2. Description of Related Art

Fatalities resulting from prehospital blood loss caused by limb wounds can be reduced with proper tourniquet placement and use. The proper placement and use of a tourniquet is critical to its efficacy, but difficult to learn. If a tourniquet is placed too close to the wound, it may be ineffective at stopping blood loss. Conversely, if the tourniquet is placed too far from the wound, use of the tourniquet may sacrifice more of the limb than is needed to stop the hemorrhaging. Overly tight application of a tourniquet may result in unnecessary loss of the tourniqueted limb. Conversely, overly loose application of a tourniquet may fail to stop the hemorrhaging and result in shock and/or death.

In view of the importance of proper tourniquet use, it is important to properly train individuals who might encounter and need to treat such wounds (e.g., soldiers, paramedics, civilians in hazardous environments, etc.). Conventionally, the use of a tourniquet has been taught by an instructor using a mannequin. When a student practices applying a tourniquet to the mannequin, the instructor must carefully supervise to ensure proper placement and application of the tourniquet. The required supervision limits class size, instructor feedback, and the amount of hands-on practice that each student receives.

Conventional tourniquet training mannequins may include a hemorrhage simulator that pumps fluid (e.g., clear or red water) out of the simulated wound until the instructor determines that the tourniquet is properly applied and manually turns off the pump.

### BRIEF SUMMARY OF THE INVENTION

One aspect of one or more embodiments of the present invention provides a limb hemorrhage trauma simulator that provides didactic and hands-on training for the prehospital treatment of a hemorrhaging limb trauma victim. The simulator simulates a wounded limb, providing simulated pulse and hemorrhage blood flow. The simulator modifies simulated hemorrhage blood flow and pulse in response to direct or tourniquet pressure applied to the limb by a student.

A further aspect of one or more embodiments of the present invention provides display of information concerning the cause of the simulated injury. For example, the simulator may include a monitor that displays an accident scene, permitting the student to assess the cause of the limb trauma. This may assist the student with tourniquet placement, among other things.

Another aspect of one or more embodiments of the present invention provides a limb hemorrhage trauma simulator that includes a simulated human limb and at least one pressure sensor operatively connected to the limb to sense pressure applied to the limb and to generate a pressure signal.

According to a further aspect of one or more of these embodiments of the present invention, the simulator includes a controller operatively connected to the at least one pressure sensor to receive the pressure signal and generate an output signal in response to the pressure signal.

According to a further aspect of one or more of these embodiments of the present invention, the simulator includes a display operatively connected to the controller. The controller is constructed and arranged to display on the display information associated with the output signal. Additionally or alternatively, the controller may be constructed and arranged to display on the display at least one simulated parameter relating to the limb in response to the output signal.

According to a further aspect of one or more of these embodiments of the present invention, the controller includes a hemodynamic model, and the controller is constructed and arranged to display on the display the at least one simulated parameter as a function of at least the hemodynamic model and the output signal. The at least one simulated parameter may include at least one of blood pressure, pulse rate, blood volume, and shock state.

According to a further aspect of one or more of these embodiments of the present invention, the simulator includes a memory operatively connected to the controller. The memory records data associated with the output signal.

According to a further aspect of one or more of these embodiments of the present invention, the simulator includes a pulse simulator operatively connected to the limb to provide the limb with a pulse. The controller may be constructed and arranged to alter at least one parameter of an output of the pulse simulator (e.g., pulse intensity or frequency) in response to the output signal.

According to a further aspect of one or more of these embodiments of the present invention, the simulated limb includes a flexible skin material. The at least one sensor is disposed beneath a surface of the skin material.

According to a further aspect of one or more of these embodiments of the present invention, the limb includes a simulated wound. The simulator further includes a fluid pump with an output passageway that includes an outlet opening disposed proximate to the simulated wound. The controller may be constructed and arranged to modify operation of the fluid pump in response to the output signal. For example, the controller may be constructed and arranged to reduce the pump's flow rate in response to a change in the output signal that signifies an increase in the sensed pressure. The controller may be constructed and arranged to operate the pump to provide a pulsating fluid flow and vary an amplitude and/or a frequency of the pulsating flow as a function of at least the output signal.

According to a further aspect of one or more of these embodiments of the present invention, the simulator includes at least one additional pressure sensor disposed proximate the simulated wound. The at least one additional pressure sensor may be positioned to sense direct pressure being applied to the simulated wound.

Another aspect of one or more embodiments of the present invention provides a method of using a limb hemorrhage trauma simulator that includes a simulated limb and at least one pressure sensor operatively connected to the limb. The method includes applying a tourniquet to the limb, and sensing via the at least one sensor a pressure applied by the tourniquet to the limb. The method may also include expelling fluid from the simulated limb at a flow rate, and modifying the flow rate in response to a pressure sensed by the at least one sensor.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a front perspective view of a limb hemorrhage trauma simulator according to an embodiment of the present invention;

FIG. 2 is a perspective view of part of a simulated limb of the simulator in FIG. 1;

FIG. 3 is a partial perspective view of the simulated limb in FIG. 1;

FIG. 4 is a flowchart showing the operation of a controller of the simulator in FIG. 1; and

FIG. 5 is a perspective view of a simulated limb according to an alternative embodiment of the present invention.

### DETAILED DESCRIPTION OF EMBODIMENTS OF THE INVENTION

A limb hemorrhage trauma simulator device 10 according to an embodiment of the present invention provides didactic and hands-on training for the prehospital treatment of a hemorrhaging limb injury. The device 10 realistically simulates a wounded limb 20, providing simulated pulse and hemorrhage blood flow.

The device 10 also provides the student with a simulated scenario in which the wound occurred. The student responds to the scenario by treating the limb 20 (e.g., applying direct pressure, tourniquet, and/or wound analysis). The device 10 modifies characteristics of the simulated limb 20 such as hemorrhage flow rate and pulse in response to the medical treatment being applied by the student.

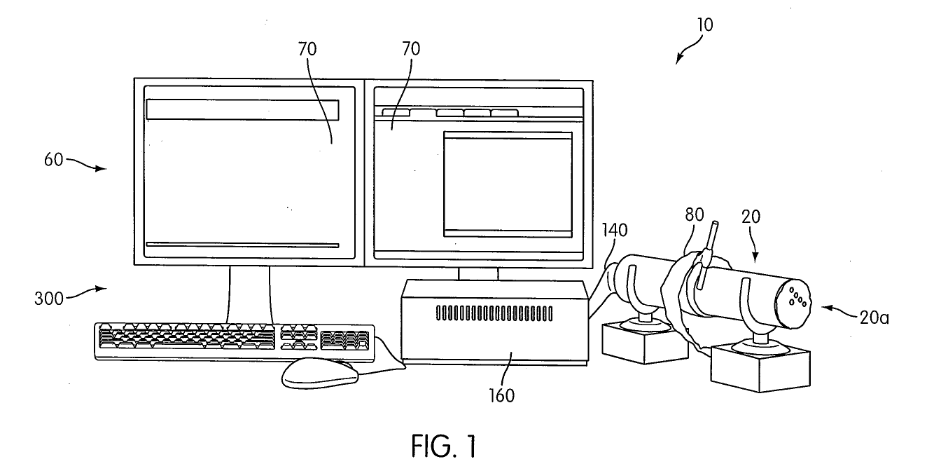

Hereinafter, the device 10 is described with reference to FIGS. 1-4. The device 10 comprises the simulated limb 20, a plurality of pressure sensors 30, a pulse simulator 40, a hemorrhage simulator 50, a controller 60, a display 70, and a tourniquet 80.

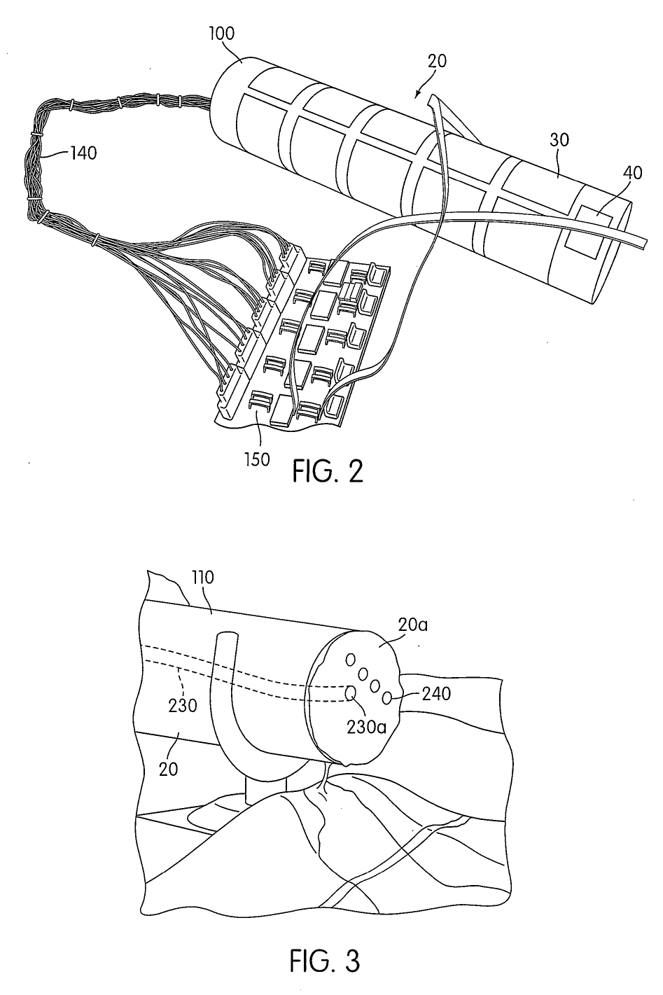

As shown in FIG. 2, the illustrated limb 20 comprises a tubular PVC pipe 100. The pipe 100 may be shaped to generally mimic the contours of a human limb. As shown in FIG. 3, simulated skin 110 encloses the pipe 100. The simulated skin 110 may comprise any suitable material for simulating soft-tissue such as skin, fat, and muscle (e.g., closed or open celled foam, silicon rubber, plastic, polymeric materials, polyurethane, etc.). A distal end 20a of the limb 20 simulates a traumatic wound.

While the use of simulated skin 110 is preferred, the materials used to create the limb 20 may be modified to be more or less realistic based on cost or other considerations. For example, the skin 110 may be omitted completely such that the structure of the limb 20 is defined entirely by the pipe 100. The pipe 100 may have a cylindrical shape or may be contoured to more closely simulate the shape of a human limb.

The illustrated limb 20 in the illustrated example is sized and shaped to simulate an upper arm. However, the limb 20 may alternatively be sized and shaped to simulate a lower arm, an elbow, a leg, or a portion of a leg without deviating from the scope of the present invention. Alternatively, the limb 20 may have a size that is about midway between an arm and a leg so as to generally simulate either limb. Alternatively, a plurality of interchangeable limbs 20 may be provided and interchangeably connected to the remainder of the device 10 through suitable connections. Different limbs 20 may simulate different traumatic wounds, and include differently positioned hemorrhage and pulse simulators 40, 50, depending on the simulated wound and wound location. The controller 60 may be designed to sense which limb 20 is attached to the device 10, and provide a trauma scenario that corresponds to the attached limb 20, as described in greater detail below.

As shown in FIGS. 2 and 3, the sensors 30 are disposed between the pipe 100 and skin 110. An intermediate mounting material may be placed between the sensors 30 and the pipe 100 to minimize local pressure variations in the sensors 30. The illustrated pressure sensors 30 comprise a 5-sensor-long by 4-sensor-wide array with each row of 4 sensors spanning the circumference of the limb 20 and each row of 5 sensors 30 extending longitudinally along the limb 20. The longitudinal rows of sensors 30 generate a signal that indicates the longitudinal position of pressure applied to the limb 20. The circumferential rows of the sensors 30 provide a signal that indicates whether a tourniquet 80 is being applied perpendicularly or skewed relative to a longitudinal direction of the limb 20. The sensors 30 combine to sense a pressure applied by the tourniquet 80 to the limb 20. Depending on the size of the limb 20 and desired precision of the sensed pressures, additional and/or fewer longitudinal or circumferential rows of sensors 30 may be used.

Each sensor 30 generates a signal that is proportional to the highest pressure applied to its surface. The illustrated sensors 30 have a range from approximately 100 g to well over 2000 g and a surface area of 2 inches by 2 inches, yielding a pressure sensitivity range of 25 to 500 grams/square inch. Gaps between adjacent sensors 30 are preferably minimized to maximize the recognition of pressures applied to the surface of the limb 20.

The sensors 30 may alternatively comprise any other suitable type of sensors that are capable of measuring a pressure or force applied by the tourniquet 80 to the limb 20. For example, according to an alternative embodiment of the present invention, the sensors 30 comprise conductive rubber. The sensors may measure pressure directly or by measuring a parameter that is related to an applied pressure (e.g., a strain gauge disposed on the pipe 100 or a flexible member cantilevered between the pipe 100 and skin 110, etc.). According to an alternative embodiment of the present invention, the sensors 30 each comprise a fluid-filled bladder that fluidly connects to a fluid pressure sensor.

The pulse simulator 40 comprises a linear actuator, such as a solenoid 40, that is spring biased toward a fully extended position and moves toward a contracted position in response to a voltage applied to it. When it is compressed by external pressure, such as a finger pressing against the spring bias, it can also move toward an extended position in response in an opposite polarity voltage being applied to it. The solenoid 40 is disposed between the pipe 100 and the skin 110, such that extension of the solenoid 40 causes the skin 110 to bulge and contraction of the solenoid 40 causes the skin 110 to return to its normal position, thereby simulating a pulse in the limb 20. The solenoid 40 is disposed toward a distal end of the limb 20 such that the solenoid 40 is disposed distally from a properly applied tourniquet 80.

While the illustrated pulse simulator 40 comprises a solenoid, the pulse simulator may alternatively comprise any other suitable controllable mechanism for simulating a pulse in the limb 20. For example, the simulator 40 may comprise a fluid bladder between the skin 110 and the pipe 100. The fluid bladder may connect to a master piston/cylinder that is driven by an electric actuator. Actuation of the actuator expands or contracts the master piston/cylinder, which, in turn, expands or contracts the bladder to simulate a pulse in the vicinity of the bladder. The bladder may be shaped to generally follow the path of a blood vessel in the limb such that the pulse may be simulated along the length of the simulated blood vessel.

According to an alternative embodiment of the present invention, the pulse simulator comprises a solenoid that selectively and proportionally compresses an elongated, fluid filled tube. The tube is disposed between the skin 110 and the pipe 100 and is generally positioned where a blood vessel would be in the limb 20. Expansion of the solenoid compresses the adjacent tube, which causes the remainder of the tube to expand under the fluid pressure. Such an embodiment provides a pulse along the length of the limb 20, and thereby enables a student to measure the pulse anywhere along the limb 20. The solenoid preferably operatively connects to the tube at a proximal side of the limb 20. Consequently, when a tourniquet 80 is applied at an intermediate longitudinal position on the limb 20, the tourniquet 80 squeezes the tube and naturally decreases or stops pulsing of the tube distal to the tourniquet 80. The proximal end of the tube may continue to pulse. The tourniquet 80 therefore naturally simulates the pulse of the limb 20, which would stop distal to the location of a properly applied tourniquet 80.

According to an alternative embodiment of the pulse simulator 40, the pulse simulator 40 comprises a row of solenoids that are disposed beneath the skin 110 and extend longitudinally along the limb 20 to follow the path of a simulated blood vessel. The controller 60 may individually control each solenoid to modify the simulated pulse over the longitudinal length of the limb 20 in response to the sensed longitudinal placement and pressure of the tourniquet 80.

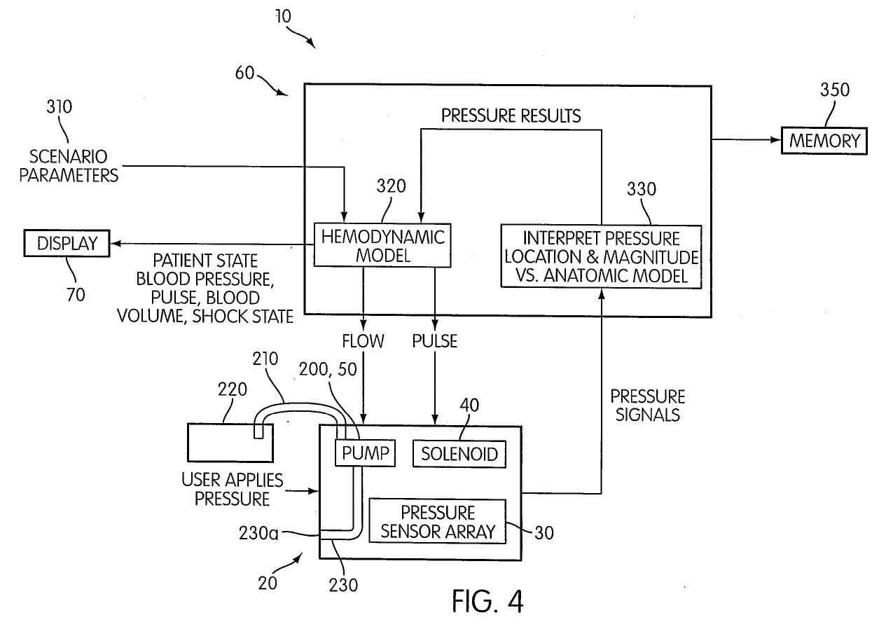

As shown in FIG. 4, the hemorrhage simulator 50 comprises a fluid pump 200, an inlet passageway 210 fluidly connecting the pump 200 to a fluid reservoir 220, and an outlet passageway 230 extending from the pump 200 to an outlet opening 230a proximate the simulated wound 20a (see FIG. 3). The pump 200 pumps fluid from the reservoir 220 out through the opening 230a to simulate hemorrhaging. The fluid may be water, colored water, or any other suitable fluid for simulating blood. The pump 50 may be disposed in any suitable location. For example, the pump 50 may be mounted on isolation bushings within an interface box 160 (see FIG. 1). The passageways 210,230 are clamped to the pump 200 to be fluid tight and the path of the passageways 210,230 is preferably routed so that they do not span electrical circuits in case of a leak. Alternatively, the pump 200 may be disposed in the pipe 100 of the limb 20 or in any other suitable location (e.g., a discrete pump 200 housing that is isolated from other electrical circuits).

The illustrated pump 200 comprises an alternating piston pump. The controller 60 operatively connects to the pump 200 to control the pump's intensity and pumping pattern to thereby simulate hemorrhaging, as described below.

While the illustrated pump 200 is an active pump, a pump according to an alternative embodiment of the present invention may be gravity-driven. For example, the reservoir 220 may be disposed higher than the outlet opening 230a. The pump 200 may comprise a proportionally-openable, solenoid controlled valve disposed between the inlet and outlet passageways 210, 230. Opening the valve causes gravity-driven fluid flow from the reservoir 220 to the outlet opening 230a to simulate hemorrhaging. The inlet passageway 210 operatively connects to a lower end of the reservoir 220 to create continuous fluid pressure in the passageway 210. Alternatively, the reservoir 220 may comprise an elastically-inflated pressurized bladder such as a rubber balloon such that the elastically expanded bladder creates the driving fluid pressure.

As shown in FIG. 3, the hemorrhage simulator 50 may additionally or alternatively represent the flow of blood via a group of light emitting diodes 240 (LEDs) (e.g., red LEDs) or other light emitters (e.g., incandescent bulbs), which could be arranged in a line or other pattern, embedded in the limb 20 proximate the simulated wound 20a near where the blood would flow out. The controller 60 operatively connects to and controls these LEDs 240 to represent the magnitude and/or presence of blood flow (e.g., number of ON LEDs 240 in proportion to simulated flow rate; intensity of light emitted by the LEDs 240 in proportion to the flow rate, etc.). The LEDs 240 could therefore replace or augment the use of the fluid pump 200 and associated passageways 210, 230 and fluid. This gives the device 10 added flexibility because it can be used when fluid is not available or not desired for practical reasons such as not wanting to collect the fluid after it is pumped out of the limb.

While the illustrated hemorrhage simulator 50 utilizes a plurality of LEDs 240, the simulator 50 may alternatively utilize a single LED or other light emitter. The hemorrhage simulator 50 may control an intensity of the light emitted by the light emitter to represent a magnitude of simulated blood flow. Alternatively, the simulator 50 may use the single light emitter in an ON/OFF manner to represent whether blood is or is not flowing out of the simulated wound 20a.

While the illustrated light emitters 240 are disposed on the limb 20 proximate the simulated wound 20a, the light emitters 240 may be alternatively disposed at any other suitable location that is perceptible by a student. According to an alternative embodiment, the hemorrhage simulator 50 is incorporated into a computer 300 (FIG. 1) such that the light emitters 240 comprise part of the display 70 and the simulated blood flow rate is displayed on the display 70.

According to a further embodiment of the hemorrhage simulator 50, the hemorrhage simulator 50 includes a sound emitting device (e.g., audio speaker, buzzer, etc.) that emits sounds representative of simulated blood flow rate (e.g., frequency of beeps in proportion to the simulated flow rate; volume of noise in proportion to flow rate, etc.). The hemorrhage simulator 50 may additionally or alternatively utilize any other suitable audible, visual, or haptic indicia to represent the presence and/or flow rate of simulated blood.

As shown in FIGS. 1 and 4, the controller 60 comprises a computer 300 that operatively connects to the pressure sensors 30, the pulse simulator 40, and the hemorrhage simulator 50 via suitable connectors (e.g., A/D converters, D/A converters, USB connections, serial connections, interface electronics boards 150, pulse width modulators (PWM generators), PIC controllers, etc.). For example, leads 140 of the sensors 30 and pulse simulator 40 extend to one or more interface electronics boards 150 (FIG. 2) that are disposed in the interface box 160 (FIG. 1). Such connectors operatively connect to the computer 300 via a suitable connection. The connection to the computer 300 preferably comprises a single USB connection to facilitate use of a variety of off-the-shelf USB-equipped computers 300 as part of the device 10.

The controller 60 operatively connects to the pulse simulator 40 to control various operation parameters of the pulse simulator 40. The controller 60 expands and contracts the simulator 40 to mimic a human pulse according to a pulsating waveform. The controller 60 changes a frequency of the pulse simulator's expansion and contraction to modify the simulated pulse rate. Similarly, the controller 60 changes an amplitude of the pulse simulator's expansion and contraction to modify the simulated strength of the pulse.

The controller 60 similarly operatively connects to and controls operation parameters of the hemorrhage simulator 50 to control fluid flow according to a pulsating waveform. For example, the controller 60 changes a frequency of the fluid flow to change the simulated pulse rate. The controller 60 may synchronize the change with changes to the frequency and timing of the pulse simulator 40. The controller 60 changes an amplitude of the fluid flow of the hemorrhage simulator 50 to simulate increased or decreased hemorrhaging.

In operation, the controller 60 utilizes any one of a variety of simulated trauma scenarios. The controller 60 operatively connects to the display 70 to display information relating to the simulated trauma scenario. Exemplary scenarios include upper arm amputation, upper leg thigh amputation, upper leg thigh through-and-through bullet wound (bleeding hole), broken bone with artery intact, broken bone and hole in artery, lower leg mine injury, hand injury with mostly soft tissue removal, foot injury, under fire battlefield situations, lacerations, punctures, etc. Each scenario may include its own discrete scenario parameters 310 (e.g., blood lost since injury, time since injury, shock state of victim, hemorrhage flow rate, wound location and severity).

The controller 60 includes a hemodynamic model 320 that calculates various simulated victim conditions (e.g., blood pressure, pulse rate, rate of change in pulse rate, pulse strength, blood volume, hemorrhage rate, shock state) as a function of one or more input parameters (e.g., trauma scenario parameters 310, tourniquet 80 pressure over time, sensed pressure from the sensors 30 and sensed location of the pressure, etc.). The controller 60 operatively connects to the display 70 to display one or more victim conditions (e.g., blood pressure, pulse rate, pulse strength, blood volume, hemorrhage rate, shock state).

As shown in FIG. 4, the controller 60 receives pressure signals from the pressure sensors 30 and interprets the pressure signals to determine the longitudinal location and magnitude of an applied tourniquet 80 force. The controller 60 may interpret whether the tourniquet 80 is applied squarely (e.g., in a direction perpendicular to the longitudinal direction of the limb 20) or obliquely (e.g., skewed) by sensing pressures in adjacent circumferential rows of pressure sensors 30.

The controller 60 compares the pressure signals to an anatomic model 330 to create an output signal. The controller 60 inputs the output signal into the hemodynamic model 320. The anatomic model 330 may correlate the pressure signals from the sensors 30 to the degree of restriction of blood flow through a limb having the simulated injury to create an output signal representative of a degree of blood flow restriction. The controller 60 may display the output signal or information associated with the output signal in a user-cognizable manner on the display 70 (e.g., sensed pressure; degree of blood flow restriction, etc.).

The sensors 30 may be calibrated so that the anatomic model 330 may correlate the pressure signals to a simulated pressure. For example, a manually pumped sphygmomanometer to which a solid-state pressure sensor is attached may be used to calibrate the sensors 30 within the limb 20. The bladder of the sphygmomanometer may be wrapped around the limb 20, aligned with a circumferential row of sensors 30, and pressurized to 300 mm Hg. The pressure is slowly allowed to decrease over a period of time such as 30 seconds. The applied pressure and the signals for the aligned circumferential row of pressure sensors 30 are monitored and calibration curves fit to the data. The process may be repeated for each circumferential row of sensors 30 to calibrate the sensors 30.

The controller 60 operates the pulse and hemorrhage simulators 40, 50 in accordance with the hemodynamic model 320. For example, according to one function of the hemodynamic model 320, the controller 60 decreases hemorrhage flow (i.e., amplitude of the flow waveform of the hemorrhage simulator 50) in proportion to an increase in tourniquet 80 pressure sensed by the sensors 30. The controller 60 may stop hemorrhage flow entirely when the sensed pressure corresponds to an appropriately positioned and applied tourniquet 80.

According to another aspect of the hemodynamic model 320, the controller 60 may decrease blood pressure, pulse strength, and hemorrhage flow rate and increase shock state in response to continued loss of simulated blood (e.g., by integrating simulator 50 flow rate over time to determine volumetric blood loss).

According to another aspect of the hemodynamic model 320, the controller 60 may decrease the pulse strength (i.e., amplitude) of the distally placed pulse simulator 40 in proportion to the sensed pressure of the tourniquet 80. If the tourniquet 80 is properly applied, the controller 60 may stop the distal pulse (and hemorrhage flow) entirely. If the pulse simulator 40 additionally includes simulation of the pulse on a proximal end of the limb 20, the controller 60 may continue to cause a proximal pulse.

The controller 60 includes a memory 350 that records pressure sensor 30 and simulation data during each trauma simulation. The controller 60 may also record elapsed time versus pressure sensor 30 readings to record how quickly a student applied a tourniquet 80 or stopped the hemorrhaging. The controller 60 may also store on the memory 350 information relating to the longitudinal positioning of the tourniquet 80, and may indicate to the student when the tourniquet 80 is being applied too close or too far from the simulated injury. The controller 60 may also store on the memory 350 information relating to the distribution of pressure circumferentially around the limb by the tourniquet 80 to determine how evenly the student has applied the tourniquet 80. The data stored in the memory 350 may be used to grade and analyze the student's performance. The controller 60 may connect to a network (e.g., internet, LAN, etc.) so that student performance may be analyzed remotely. The controller 60 may itself analyze student performance during or after a trauma simulation and provide appropriate feedback to the student (e.g., visual feedback via the display 70, audio feedback, written feedback via a report printed on an associated printer, etc.).

While the illustrated controller 60 comprises a computer, the controller 60 may alternatively comprise any other suitable controller without deviating from the scope of the present invention (e.g., a stand-alone controller with appropriate electronics components, etc.).

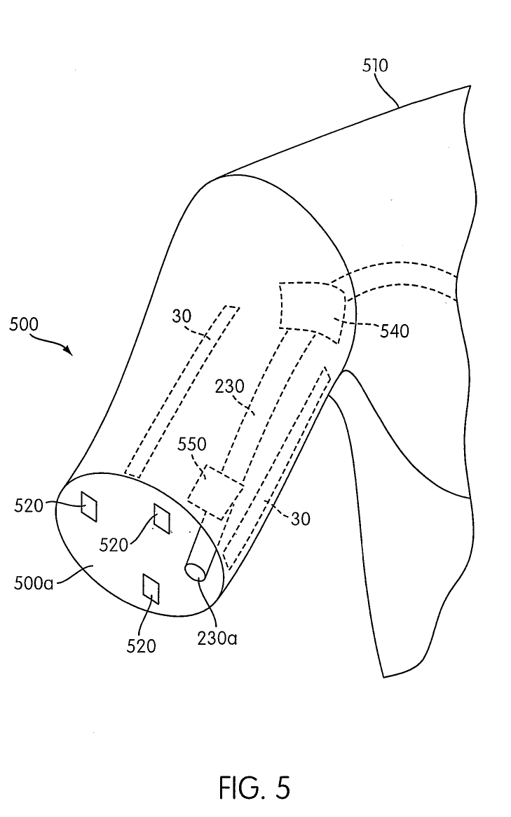

FIG. 5 illustrates a simulated limb 500 according to an alternative embodiment of the present invention. The simulated limb 500 may replace or be interchangeable with the previously described limb 20. The simulated limb 500 is connected to a mannequin 510. As in the limb 20, the limb 500 includes a plurality of pressure sensors 30 to measure tourniquet 80 placement and pressure. The limb 500 includes additional sensors 520 in the vicinity of the simulated injury 500a. The sensors 520 measure direct pressure applied to the simulated wound 500a. The controller 60 and hemodynamic model 320 may be modified for use with the limb 500 to account for direct pressure applied to the simulated wound 500a and sensed by the sensors 520. For example, if the simulated wound is minor enough according to the trauma scenario, the controller 60 may stop hemorrhaging completely in response to sufficient sensed direct pressure, even in the absence of a tourniquet 80.

As shown in FIG. 5, the simulated limb 500 includes proximal and distal pulse simulators 540, 550. The controller 60 and hemodynamic model 320 may be modified to individually control the simulators 540, 550. For example, if a tourniquet 80 is properly applied above the distal simulator 540, the controller 60 may stop the pulse of the distal simulator 540 completely to simulate the absence of blood flow and pressure below the tourniquet 80. If the tourniquet 80 is applied correctly, the controller 60 may maintain a pulse in the proximal simulator 550, but may modify the pulse to simulate the reduced blood flow caused by the tourniquet 80.

The device 10 may additionally comprise a didactic training component. The didactic training component may be integrated into the controller 60 or comprise a stand alone component (e.g., software that is independently run on the computer 300). The didactic training component is designed to train students to treat limb trauma victims. The training component may include audio, video, multimedia, and/or interactive components that are output through the computer 300 and display 70. The training component may provide education on limb anatomy and medical treatment for trauma victims. The education may include 3D models of the human anatomy. The training component may include interactive quizzes and require students to achieve a sufficient knowledge of a particular training module before proceeding to the next training module or a hands-on trauma simulation utilizing the limb 20. Quiz scores may be recorded in the memory 350. Individual students may be assigned user names/passwords such that the device 10 can track each individual's progress through the didactic and hands-on training components of the device 10.

The device 10 may provide didactic and hands-on limb trauma training to students even in the absence of a live instructor. Students may therefore progress through the training at their own pace.

The didactic training component may include one or more discrete modules (e.g., computer programs or videos) that students may progress through at their own pace prior to classroom practice with the hands-on portion of the device 10. For example, cognitive learning modules may be delivered via the Internet or CD-ROM in advance of using the hands-on portion of the device 10.

While the device 10 can be used to train and test students, the device 10 may additionally or alternatively be used to test and analyze tourniquet devices and/or tourniquet methods. The sensors 30 may be used to measure how well a tested tourniquet device or method functions. The controller 60 may be modified to record and/or analyze the pressure signals and time to determine the effectiveness and/or speed of application of a prototype tourniquet.

While the illustrated controller 60 includes a feedback loop that controls the pulse and hemorrhage simulators 40, 50 in response to sensed pressures from the sensors 30, one or both of the simulators 40, 50 may be omitted without deviating from the scope of the present invention. If both simulators 40, 50 are omitted, the controller 60 may display the simulated hemorrhage and pulse information on the display 70. Additionally or alternatively, the controller 60 may simply function as a monitor that monitors and visually or audibly displays or records the sensed pressure applied to the limb 20.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A limb hemorrhage trauma simulator comprising:
a simulated human limb; and
at least one pressure sensor operatively connected to the limb to sense pressure applied to the limb and to generate a pressure signal.

2. The simulator of claim 1, further comprising a controller operatively connected to the at least one pressure sensor to receive the pressure signal and generate an output signal in response to the pressure signal.

3. The simulator of claim 2, further comprising a display operatively connected to the controller, the controller being constructed and arranged to display on the display information associated with the output signal.

4. The simulator of claim 2, further comprising a display operatively connected to the controller, wherein the controller is constructed and arranged to display on the display at least one simulated parameter relating to the limb in response to the output signal.

5. The simulator of claim 4, wherein:
the controller includes a hemodynamic model, and
the controller is constructed and arranged to display on the display the at least one simulated parameter as a function of at least the hemodynamic model and the output signal.

6. The simulator of claim 4, wherein the at least one simulated parameter comprises at least one of blood pressure, pulse rate, blood volume, and shock state.

7. The simulator of claim 2, further comprising a memory operatively connected to the controller, the memory recording data associated with the output signal.

8. The simulator of claim 1, further comprising a pulse simulator operatively connected to the limb to provide the limb with a pulse.

9. The simulator of claim 8, further comprising a controller operatively connected to the at least one pressure sensor to receive the pressure signal and generate an output signal in response to the pressure signal, wherein the controller is constructed and arranged to alter at least one parameter of an output of the pulse simulator in response to the output signal.

10. The simulator of claim 9, wherein the at least one parameter comprises pulse intensity.

11. The simulator of claim 9, wherein the at least one parameter comprises pulse frequency.

12. The simulator of claim 1, wherein the simulated limb comprises a flexible skin material, and wherein the at least one sensor is disposed beneath a surface of the skin material.

13. The simulator of claim 1, wherein the limb includes a simulated wound, and wherein the simulator further comprises a hemorrhage simulator that is constructed and arranged to provide indicia representative of the simulated blood flow out of the simulated wound.

14. The simulator of claim 13, further comprising a controller operatively connected to the at least one pressure sensor to receive the pressure signal and generate an output signal in response to the pressure signal, the controller being constructed and arranged to alter the indicia of the simulated blood flow as a function of at least the output signal.

15. The simulator of claim 14, wherein the hemorrhage simulator comprises at least one light emitter disposed proximate the simulated wound, the indicia comprising light emitted by the at least one light emitter.

16. The simulator of claim 14, wherein the hemorrhage simulator further comprises a fluid pump with an output passageway that includes an outlet opening disposed proximate to the simulated wound.

17. The simulator of claim 16, wherein the indicia comprises fluid flow rate out of the outlet opening, and wherein the controller is constructed and arranged to reduce the flow rate in response to a change in the output signal that signifies an increase in the sensed pressure.

18. The simulator of claim 16, wherein the controller is constructed and arranged to operate the pump to provide a pulsating fluid flow out of the outlet opening.

19. The simulator of claim 18, wherein the indicia comprises an amplitude of the pulsating fluid flow.

20. The simulator of claim 18, wherein the indicia comprises a frequency of the pulsating fluid flow.

21. The simulator of claim 14, further comprising a pulse simulator operatively connected to the limb to provide the limb with a simulated pulse, wherein the controller operatively connects to the pulse simulator, the controller being constructed and arranged to alter at least one parameter of an output of the pulse simulator as a function of at least the output signal.

22. The simulator of claim 13, further comprising at least one additional pressure sensor disposed proximate the simulated wound, the at least one additional pressure sensor being positioned to sense direct pressure being applied to the simulated wound.

23. A method of using a limb hemorrhage trauma simulator comprising a simulated limb and at least one pressure sensor operatively connected to the limb, the method comprising:
applying a tourniquet to the limb; and
sensing via the at least one sensor a pressure applied by the tourniquet to the limb.

24. The method of claim 23, further comprising:
expelling fluid from the simulated limb at a flow rate; and
modifying the flow rate in response to a pressure sensed by the at least one sensor.
